(19) United States
(12) Patent Application Publication
(10) Pub. No.: US 2026/0161437 A1
(43) Pub. Date: Jun. 11, 2026

(54) PROCESSOR OPERATING A PHYSICAL MACHINE AND A VIRTUAL MACHINE, AND PROCESSOR ACCELERATION METHOD

(71) Applicant: Shanghai Zhaoxin Semiconductor Co., Ltd., Shanghai (CN)

(72) Inventors: Zhiguang NI, Shanghai (CN); Yafeng WANG, Beijing (CN); Lei CUI, Beijing (CN); Yonghao HAI, Shanghai (CN)

(21) Appl. No.: 19/260,849

(22) Filed: Jul. 7, 2025

(30) Foreign Application Priority Data
Dec. 10, 2024 (CN) 202411814231.6

(51) Int. Cl. G06F 9/455; G06F 9/30

(52) U.S. Cl. CPC G06F 9/45541; G06F 9/30018; G06F 9/30047; G06F 9/45558; G06F 2009/45583

(57) ABSTRACT

A processor operating a physical machine and a virtual machine is shown. The processor includes a virtualization hardware accelerator, which pre-caches whole instruction content, read from a virtual machine memory, of a target trigger instruction in a virtual machine control data structure, wherein the target trigger instruction is operative to trigger a virtual machine exit event and needs instruction emulation on the physical machine. A virtual machine hypervisor run by the physical machine in software obtains the instruction content of the target trigger instruction from the virtual machine control data structure, and performs instruction decoding and instruction emulation for the target trigger instruction based on the obtained instruction content.

### CROSS REFERENCE TO RELATED APPLICATIONS

This Application claims priority of China Patent Application No. 202411814231.6, filed on Dec. 10, 2024, the entirety of which is incorporated by reference herein.

### BACKGROUND OF THE DISCLOSURE

### Field of the Disclosure

The present invention relates to a processor that operates a physical machine and a virtual machine.

### Description of the Related Art

A virtual machine (VM) is another computer emulated on a physical computer by software emulation.

FIG. 1 depicts operations of a conventional virtual machine (VM). In addition to a physical machine 102, a computer system 100 includes a virtual machine (VM) 104 run by software emulation performed by the processor. As shown, the virtual machine 104 executes a trigger instruction 106 to trigger a virtual machine exit (VM exit) event 108 for switching back to the operations of the physical machine 102. In step 110, the software determines whether it is necessary to emulate the trigger instruction 106. If not, the physical machine 102 performs the other procedures of the virtual machine exit event 108. On the contrary, if there is a need for instruction emulation, the physical machine 102 performs the instruction emulation procedure 114.

The instruction emulation procedure 114 includes three steps: instruction fetching 116; instruction decoding 118; and instruction emulation 120. Through the instruction fetching 116, the instruction contents are read from a virtual machine memory 122. Through the instruction decoding 118, the instruction contents are decoded and analyzed. Step 118 also determines whether the complete instruction has been fetched from the virtual machine memory 122. The instruction fetching is repeated until the complete instruction has been fetched and decoded. Then, instruction emulation 120 is performed. Note that the instruction is fetched sector by sector (in units of sectors wherein each sector has a predetermined size.), and the step of instruction fetching 116 may be repeated several times to fetch the whole instruction content of the trigger instruction 106.

However, for the physical machine 102, fetching (116) each sector of instruction from the virtual machine memory 122 involves the time-consuming address translation. A guest virtual address (GVA) must be translated into a guest physical address (GPA), and the GPA must be translated into a host virtual address (HVA). In addition, the instruction fetching 116 involves copying instruction content from the user side to the kernel side. For example, an instruction, copy_from_user, may be executed to copy the instruction content from the user side to the kernel side. Such instruction content copy also consumes a considerable number of processor cycles. The repeatedly executed instruction fetching 116 consumes a large number of processor cycles on the address translation (GVA→GPA→HVA), and so as the instruction content copy (from the user side to the kernel side) for the multiple sectors of instruction contents.

How to speed up the operations of a virtual machine is an important issue in the technical field.

### BRIEF SUMMARY OF THE DISCLOSURE

A processor acceleration technology is shown.

A processor with a virtualization hardware accelerator in accordance with an exemplary embodiment of the disclosure is shown. The virtualization hardware accelerator pre-caches whole instruction content, read from a virtual machine memory, of a target trigger instruction in a virtual machine control data structure (VMCS), wherein the target trigger instruction is operative to trigger a virtual machine exit event and needs instruction emulation on the physical machine. A virtual machine hypervisor run by the physical machine in software obtains the instruction content of the target trigger instruction from the virtual machine control data structure (VMCS), and performs instruction decoding and instruction emulation for the target trigger instruction based on the obtained instruction content.

In an exemplary embodiment, without address translation between the physical machine and the virtual machine, the virtual machine hypervisor reads the virtual machine control data structure according to a host virtual address, to obtain the instruction content of the target trigger instruction.

In an exemplary embodiment, without copying instruction content from the user side to the kernel side, the virtual machine hypervisor reads the virtual machine control data structure to obtain the instruction content of the target trigger instruction.

In an exemplary embodiment, the virtual machine hypervisor uses a single read operation to obtain the instruction content of the target trigger instruction from the virtual machine control data structure.

According to the proposed technology, the emulation procedure for a target trigger instruction does not repeatedly consume a large number of processor cycles on address translation (GVA→GPA→HVA) and instruction content copy (from user side to kernel side). The processor is significantly accelerated.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts operations of a conventional virtual machine (VM);

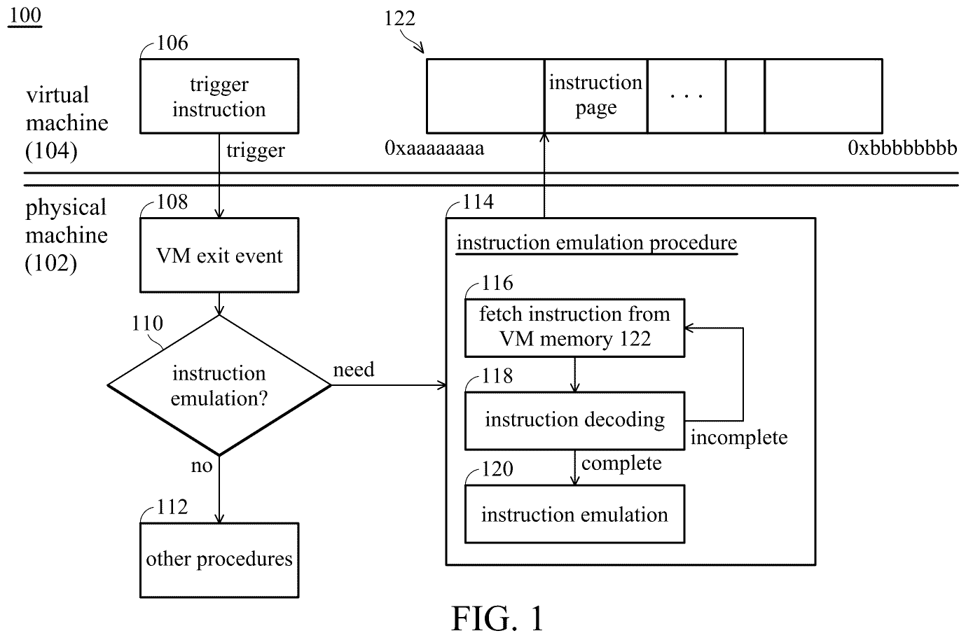

FIG. 2 illustrates a virtual machine control data structure (VMCS) 200 in accordance with an exemplary embodiment of the disclosure;

FIG. 3 illustrates the operations of a virtual machine (VM) in accordance with an exemplary embodiment of the disclosure; and

FIG. 4 illustrates a computer system 400 in accordance with an exemplary embodiment of the disclosure.

### DETAILED DESCRIPTION OF THE DISCLOSURE

The following description shows various exemplary embodiments of the present disclosure, but is not intended to limit the content of the present disclosure. The actual scope of the disclosure should be defined in accordance with the appended claims. The various units, modules, or functional blocks described below may be implemented by a combination of hardware, software, and firmware, and may also include special circuits. The presented circuits, units, modules, or functional blocks are not limited to being implemented separately, but may be combined together to share certain structures.

Instruction pre-caching in a virtualization computing scenario is shown, which accelerates the instruction fetching of a instruction emulation procedure.

Certain instructions executed by a virtual machine trigger a virtual machine exit event, and a software-implemented virtual machine hypervisor is required to emulate the trigger instruction. The instruction emulation procedure is as described above, including three steps: instruction fetching; instruction decoding; and instruction emulation. In software design, the instruction length is not fixed (but not exceeding a specific number of bytes; for example, one x86 instruction is limited within 15 bytes). By the traditional software, an instruction is fetched in sectors. It checks whether the complete instruction is fetched every time a sector of instruction is fetched. Such repeatedly performed instruction fetching repeats the time-consuming address translation (GVA→GPA→HVA) and instruction content copy (from the user side to the kernel side). In an exemplary embodiment, the hardware is specially designed to accelerate the instruction fetching for the instruction emulation procedure.

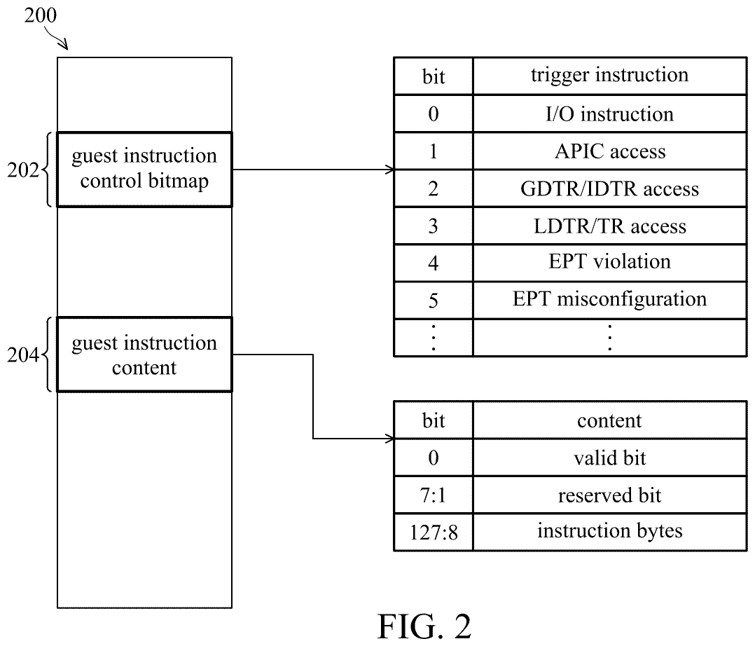

Corresponding to the improved hardware design, a special virtual machine control data structure (VMCS) is proposed. Through the virtual machine control data structure (VMCS), the virtual machine communicates with the physical machine. In the virtual machine control data structure (VMCS), it stores the following contents: the status of the physical machine (status of CPU); the status of the virtual machine (vCPU); and the running logic of the virtual machine. FIG. 2 illustrates a virtual machine control data structure (VMCS) 200 in accordance with an exemplary embodiment of the disclosure. The virtual machine control data structure 200 is specially designed to include two special fields.

In the first field, it records a guest instruction control bitmap 202. Each bit of the guest instruction control bitmap 202 corresponds to a trigger instruction that triggers a VM exit event. For a trigger instruction that will be used as a simulation target by a physical machine, the corresponding bit in the guest instruction control bitmap 202 is asserted to 1, indicating that the instruction contents of the trigger instruction need to be pre-cached. The illustrated guest instruction control bitmap 202 manage pre-fetching of a variety of trigger instructions. These trigger instructions includes: an input/output instruction that triggers the VM exit event; an APIC access request that triggers the VM exit event; a register (GDTR/IDTR) access request that triggers the VM exit event; a register (LDTR/TR) access request that triggers the VM exit event; a page table (EPT) violation event that triggers the VM exit event; a page table (EPT) misconfiguration event that triggers the VM exit event; etc. In an exemplary embodiment, a page table (EPT) misconfiguration event caused by a page table format error requires instruction emulation and may frequently happen. Thus, the corresponding bit in the guest instruction control bitmap 202 is asserted to 1.

According to the guest instruction control bitmap 202, the trigger instruction corresponding to an asserted bit will be regarded as the emulation target (regarded as a target trigger instruction), the hardware of the disclosure records the complete instruction content of the target trigger instruction in the second field of the virtual machine control data structure (VMCS) 200, to be directly accessed by the later instruction emulation procedure. As shown, the second field in the virtual machine control data structure (VMCS) 200 stores the guest instruction content 204. Bit [0] is operative to show a valid bit. Bits [7:1] are reserved bits. Bits [127:8] provide a full 15 bytes (maximum instruction size) as instruction bytes to completely pre-fetch the instruction contents of the trigger instruction.

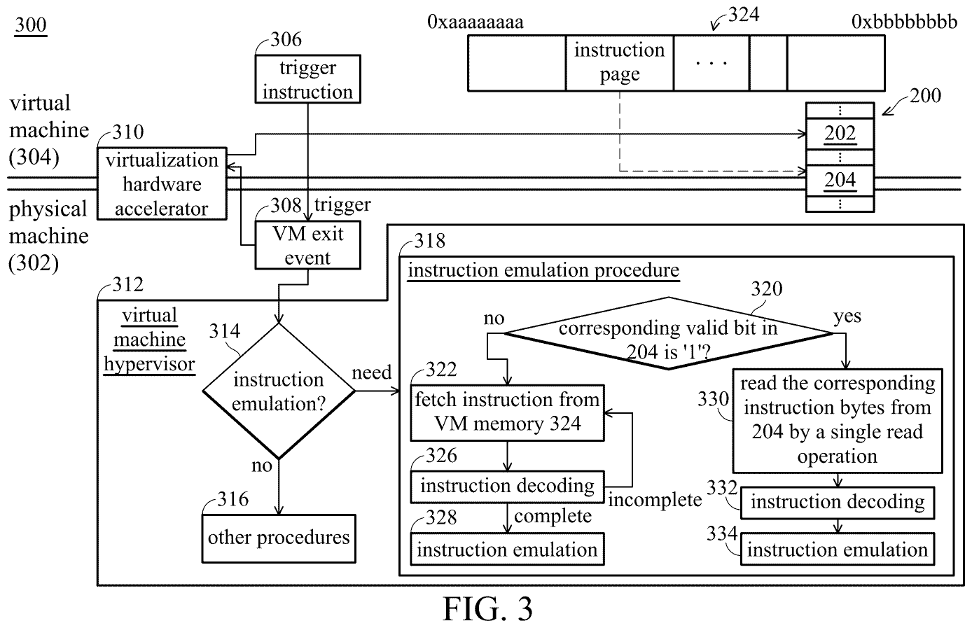

FIG. 3 illustrates the operations of a virtual machine (VM) in accordance with an exemplary embodiment of the disclosure. In addition to a physical machine 302, the computer system 300 operates the processor to provide a virtual machine 304 by software emulation. When the virtual machine 304 executes a trigger instruction 306 to switch back to the physical machine 302 and cause a virtual machine exit event 308, a virtualization hardware accelerator 310, implemented by processor hardware in the disclosure, acts accordingly.

The virtualization hardware accelerator 310 acts based on the guest instruction control bitmap 202 maintained in the virtual machine control data structure (VMCS) 200. If the bit corresponding to the trigger instruction 306 on the guest instruction control bitmap 202 is ‘1’, it means that the trigger instruction 306 is a target trigger instruction, whose instruction content should be pre-cached. The virtualization hardware accelerator 310 pre-caches the instruction content about the target trigger instruction (306) from the virtual machine memory 324 to the virtual machine control data structure (VMCS) 200 to fill in the instruction bytes [127:8] of the guest instruction content 204, and asserts the valid bit [0] of the guest instruction content 204 to 1. In an exemplary embodiment, the virtualization hardware accelerator 310 writes the complete instruction content into the instruction bytes [127:8] of the guest instruction content 204 at one time (not necessarily filling up 15 bytes, depending on the instruction length). Therefore, the address translation (GVA→GPA→HVA) only occurs once, and the instruction content copy (from the user side to kernel side) also occurs once (e.g., through a single read procedure), which is quite fast.

In response to a virtual machine exit event 308, a virtual machine hypervisor 312 operates on the physical machine 302, which is a software design. The virtual machine hypervisor 312 determines in step 314 whether it is necessary to emulate the trigger instruction 306. If not, the physical machine 302 performs the other procedures for the virtual machine exit event in step 316. On the contrary, if there is a need for instruction emulation, the physical machine 302 performs the instruction emulation procedure 318.

In step 320, the instruction emulation procedure 318 checks the valid bit [0] of the guest instruction content 204 of the virtual machine control data structure (VMSC) 200. If it is not asserted to 1, the procedure performs step 322 for instruction fetching, to load the instruction from the virtual machine memory 324. Then, step 326 is performed to decode and analyze the fetched instruction. It is determined whether a complete instruction has been obtained. If it is not a complete instruction, the procedure repeats step 322 and continues to fetch the remaining instruction content from the virtual machine memory 324 until the complete instruction is obtained. Then, step 328 is performed for instruction emulation.

If step 320 determines that the valid bit [0] of the guest instruction content 204 is 1, the procedure proceeds to step 330 to read out the complete 15 bytes (the maximum instruction size) from the instruction bytes [127:8] of the guest instruction content 204 at one time (e.g., in a single read operation). Next, step 332 performs instruction decoding, and analyzes the complete instruction content from the complete 15-byte data, and passes it to step 334 for instruction emulation.

In particular, in step 330, the instruction content is read from the virtual machine control data structure (VMCS) 200 according to a host virtual address (HVA) recognizable at the physical machine 302. Thus, fetching the complete instruction through a single read operation is allowed, unlike step 322 which repeatedly reads the virtual machine memory 324 to fetch the instruction content in units of sectors. The repeatedly performed address translation (GVA→GPA→HVA) and instruction content copy (from user side to kernel side) of step 322 are not required in step 330. The computer system 300 is significantly accelerated.

In summary, compared with the conventional technology, the hardware may be specially designed in the disclosure. To deal with the virtual machine exit event caused by the frequent trigger instruction with a necessary of instruction emulation, the instruction content is pre-cached in the virtual machine control data structure (VMCS) 200 by the hardware, and thereby the instruction emulation procedure performed by the virtual machine hypervisor 312 is accelerated. In particular, a control interface in software design is proposed in the disclosure. Through the control interface, the guest instruction control bitmap 202 is flexibly programmed, to show which types of trigger instructions are supposed to be pre-cached in the virtual machine control data structure (VMCS) 200 to form the guest instruction content 204.

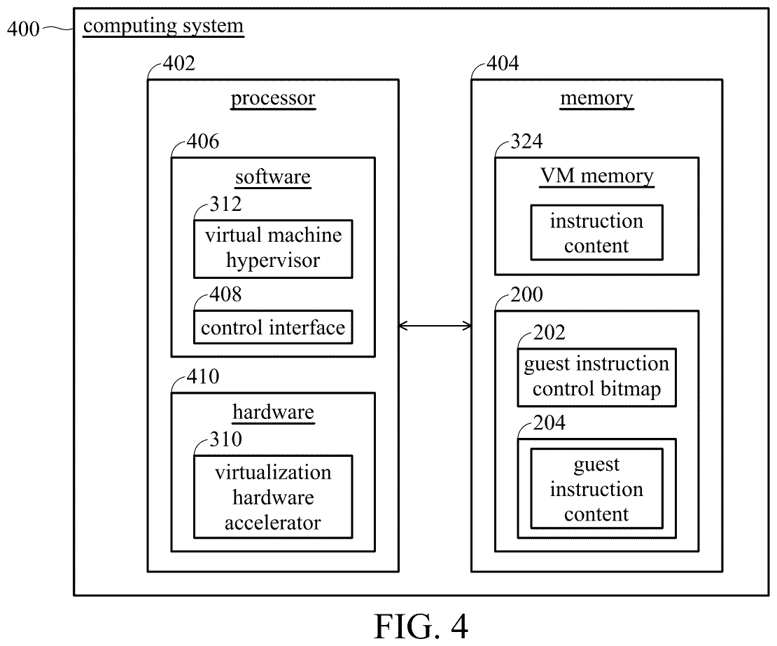

FIG. 4 illustrates a computer system 400 in accordance with an exemplary embodiment of the disclosure, which includes a processor 402 and a memory 404 coupled to the processor 402. The memory 404 is allocated to form the aforementioned virtual machine memory 324 and the aforementioned virtual machine control data structure (VMCS) 200. The software 406 of the processor 402 not only runs the virtual machine 304, but also implements the aforementioned virtual machine hypervisor 312 and the related control interface 408. Through the control interface 408, the guest instruction control bitmap 202 is programmed. The hardware 408 of the processor 402 includes the aforementioned virtualization hardware accelerator 310. Based on the guest instruction control bitmap 202, the virtualization hardware accelerator 310 determines whether to pre-cache the instruction content in the virtual machine control data structure (VMCS) 200. The virtual machine hypervisor 312 determines whether to obtain instruction content from the virtual machine memory 324 or from the guest instruction content 204 of the virtual machine control data structure (VMCS) 200.

The technology may be further used to implement a processor acceleration method. A physical machine 302 and a virtual machine 304 operate according to the disclosed method. Corresponding to a target trigger instruction that triggers a virtual machine exit event and needs to be emulated by the physical machine 302, the whole instruction content of the target trigger instruction is read from the virtual machine memory 324 and pre-cached in the virtual machine control data structure (VMCS) 200. The virtual machine hypervisor 312 implemented by software on the physical machine 302 obtains the instruction content of the target trigger instruction from the virtual machine control data structure (VMCS) 200, and then performs instruction decoding (332) and instruction emulation (334) based on the obtained instruction content for the target trigger instruction.

Any technology that uses a virtual machine control data structure (VMCS) 200 to pre-cache the instruction content and so that the instruction emulation procedure obtains the instruction content from the virtual machine control data structure (VMCS) 200 rather than from the virtual machine memory 324 should be considered within the scope of the disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A processor operating a physical machine and a virtual machine, comprising:
a virtualization hardware accelerator, pre-caching whole instruction content, read from a virtual machine memory, of a target trigger instruction in a virtual machine control data structure, wherein the target trigger instruction is operative to trigger a virtual machine exit event and needs instruction emulation on the physical machine,
wherein a virtual machine hypervisor run by the physical machine in software obtains the instruction content of the target trigger instruction from the virtual machine control data structure, and performs instruction decoding and instruction emulation for the target trigger instruction based on the obtained instruction content.

2. The processor as claimed in claim 1, wherein:
without address translation between the physical machine and the virtual machine, the virtual machine hypervisor reads the virtual machine control data structure according to a host virtual address, to obtain the instruction content of the target trigger instruction.

3. The processor as claimed in claim 2, wherein:
without copying data from a user side to a kernel side, the virtual machine hypervisor reads the virtual machine control data structure to obtain the instruction content of the target trigger instruction.

4. The processor as claimed in claim 3, wherein:
the virtual machine hypervisor obtains the instruction content of the target trigger instruction from the virtual machine control data structure using a single read operation.

5. The processor as claimed in claim 1, providing a control interface in software, to program a guest instruction control bitmap in the virtual machine control data structure through the control interface, wherein the guest instruction control bitmap marks which of a plurality of trigger instructions causing the virtual machine exit event are permitted to work as the target trigger instruction.

6. The processor as claimed in claim 5, wherein:
in response to the virtual machine executing a trigger instruction, the virtualized hardware accelerator queries the guest instruction control bitmap recorded in the virtual machine control data structure, to determine whether the trigger instruction works as the target trigger instruction.

7. The processor as claimed in claim 6, wherein:
corresponding to the target trigger instruction, the virtualization hardware accelerator pre-caches all of the instruction content of the target trigger instruction in instruction bytes of a guest instruction content contained in the virtual machine control data structure, and asserts a valid bit of the guest instruction content to 1; and
according to the valid bit asserted to 1, the virtual machine hypervisor obtains the instruction content of the target trigger instruction from the instruction bytes of the guest instruction content, and performs instruction decoding and instruction emulation on the obtained instruction content.

8. The processor as claimed in claim 7, wherein:
in the virtual machine control data structure, size of the instruction bytes allocated in each guest instruction content is the same size as a maximum instruction.

9. The processor as claimed in claim 7, wherein:
if the trigger instruction does not work as the target trigger instruction but needs to be emulated by the physical machine, a corresponding valid bit is not 1, and the virtual machine hypervisor obtains the instruction content of the trigger instruction from the virtual machine memory to perform instruction decoding and instruction emulation.

10. The processor as claimed in claim 9, wherein:
corresponding to the trigger instruction not working as the target trigger instruction but having the need to be emulated by the physical machine, the virtual machine hypervisor performs address translation between the physical machine and the virtual machine to get a host virtual address, and reads the virtual machine memory according to the host virtual address to obtain the instruction content of the trigger instruction,
wherein the virtual machine hypervisor obtains the instruction content of the trigger instruction from the virtual machine memory by copying data from a user side to a kernel side in units of sectors, and each sector has a predetermined size.

11. A processor acceleration method for operating a physical machine and a virtual machine, comprising:
pre-caching whole instruction content, read from a virtual machine memory, of a target trigger instruction in a virtual machine control data structure, wherein the target trigger instruction is operative to trigger a virtual machine exit event and needs instruction emulation on the physical machine,
wherein a virtual machine hypervisor run by the physical machine in software obtains the instruction content of the target trigger instruction from the virtual machine control data structure, and performs instruction decoding and instruction emulation for the target trigger instruction based on the obtained instruction content.

12. The processor acceleration method as claimed in claim 11, wherein:
without address translation between the physical machine and the virtual machine, the virtual machine hypervisor reads the virtual machine control data structure according to a host virtual address, to obtain the instruction content of the target trigger instruction.

13. The processor acceleration method as claimed in claim 12, wherein:
without copying data from a user side to a kernel side, the virtual machine hypervisor reads the virtual machine control data structure to obtain the instruction content of the target trigger instruction.

14. The processor acceleration method as claimed in claim 13, wherein:
the virtual machine hypervisor obtains the instruction content of the target trigger instruction from the virtual machine control data structure using a single read operation.

15. The processor acceleration method as claimed in claim 11, further comprising:
providing a control interface in software, to program a guest instruction control bitmap in the virtual machine control data structure through the control interface, wherein the guest instruction control bitmap marks which of a plurality of trigger instructions causing the virtual machine exit event are permitted to work as the target trigger instruction.

16. The processor acceleration method as claimed in claim 15, further comprising:
in response to the virtual machine executing a trigger instruction, querying the guest instruction control bitmap recorded in the virtual machine control data structure, to determine whether the trigger instruction works as the target trigger instruction.

17. The processor acceleration method as claimed in claim 16, wherein:
the instruction content of the target trigger instruction is pre-cached in instruction bytes of a guest instruction content contained in the virtual machine control data structure, and a valid bit of the guest instruction content is asserted to 1; and
according to the valid bit asserted to 1, the virtual machine hypervisor obtains the instruction content of the target trigger instruction from the instruction bytes of the guest instruction content, and performs instruction decoding and instruction emulation on the obtained instruction content.

18. The processor acceleration method as claimed in claim 17, wherein:
in the virtual machine control data structure, size of the instruction bytes allocated in each guest instruction content is the same size as a maximum instruction.

19. The processor acceleration method as claimed in claim 17, wherein:
if the trigger instruction does not work as the target trigger instruction but needs to be emulated by the physical machine, a corresponding valid bit is not 1, and the virtual machine hypervisor obtains the instruction content of the trigger instruction from the virtual machine memory to perform instruction decoding and instruction emulation.

20. The processor acceleration method as claimed in claim 19, wherein:
corresponding to the trigger instruction not working as the target trigger instruction but having the need to be emulated by the physical machine, the virtual machine hypervisor performs address translation between the physical machine and the virtual machine to get a host virtual address, and reads the virtual machine memory according to the host virtual address to obtain the instruction content of the trigger instruction,
wherein the virtual machine hypervisor obtains the instruction content of the trigger instruction from the virtual machine memory by copying data from a user side to a kernel side in units of sectors, and each sector has a predetermined size.
